(19) United States
(12) Patent Application Publication
(10) Pub. No.: US 2001/0051973 A1
(43) Pub. Date: Dec. 13, 2001

(54) System, method and computer program product for a locator service

(75) Inventors: R. Shane Green, Washington, DC (US); Edin Saracevic, Washington, DC (US); Tarik Kurspahic, McLean, VA (US); Michael D. Sylvester, Washington, DC (US)

Correspondence Address: STERNE, KESSLER, GOLDSTEIN & FOX PLLC, 1100 NEW YORK AVENUE, N.W., SUITE 600, WASHINGTON, DC, 20005-3934, US

(73) Assignee: POI Systems, Inc.

(21) Appl. No.: 09/876,111

(22) Filed: Jun. 8, 2001

Related U.S. Application Data
(60) Provisional application No. 60/210,020, filed on Jun. 8, 2000.

(51) Int. Cl. G06F 15/16

(52) U.S. Cl. 709/201

(57) ABSTRACT

A method, system, and computer program product that provides locator services. A locator system includes a locator server that handles location requests received from a application server and/or over a network such as the Internet, and a database server coupled to a locator server. An Internet-enabled locator method includes a user entering a location code in an interface, searching for matching locales, and providing location information pertaining to the matching locales to a user.

### BACKGROUND OF THE INVENTION

1. Field of the Invention

The invention relates generally to location and directory services.

2. Related Art

Worldwide convergence of telecommunications technology has brought many services into new areas of operation.

Telecommunications systems are now available which integrate a public switched telephone network (PSTN) and the Internet. A public switched telephone network (PSTN) is also referred to as a plain old telephone system (POTS). The Internet can be any network or combination of networks that support packet-switching. Such a network can include, but is not limited to, a network supporting the Internet Protocol (IP) and related protocols.

The use of maps and guidebooks as aids in locating specific locales, such as restaurants, is well-known. However, these aids are not readily transportable into the digital realm. Even though the integration of services and the Internet has created an enormous enthusiasm, the implementation and success of such systems has been hindered due to the lack of a scalable, universally-applicable locator service.

Additionally, classic communications systems on the PSTN require a user to enter location request information into the specific device (i.e., a telephone) and interpret the results.

Furthermore, conventional locator systems are not readily searchable based on factors which may be ascertainable by a user.

Therefore, in view of the above, what is needed is a system, method and computer program product for a locator service. Further, what is needed is a system, method and computer program product that allows a user to initiate location queries from a browser (or similarly functioning console and/or device) to obtain location information. Such a system would provide accessible location services by providing search functionality over the telecommunications systems. Furthermore, what is needed is a system, method and computer program product that enables users to access location information, request locations, and receive locator services (including from directions to a specific location) from any physical location.

### SUMMARY OF THE INVENTION

The invention is directed to a system, method and computer program product for locator services that satisfies the above-stated needs. The method of the present invention involves a user entering a location code into an interface. For example, a telephone, cellular phone, portable digital assistant (PDA), or other device. The interface containing a location request form. The call request form containing one or more location query fields. In one embodiment, users may use the interface of the present invention to create, add, modify, and delete previously queried location information. In another embodiment, the interface includes advertisements. In yet another embodiment, the interface is a queue from a telephone service upon which a location code is entered.

The locator system of the invention includes a locator server, a locator database, and an application server. In one embodiment, the system contains numerous locator servers, locator databases, and application servers operating either in a redundant (serial) manner or in a distributed (parallel) manner. In another embodiment, the application server provides text to speech functionality, thereby allowing users to speak in a location request and receive location information in a similar manner.

One advantage of the invention is that user obtain location information over a telephone.

Another advantage of the invention is that users may quickly and efficiently access location information based on the location code.

Yet another advantage of the invention is that advertisements can be displayed by the interface in such a manner that a user can be presented with additional details about the products and/or services being advertised. Furthermore, users can call request to be connected to any displayed advertiser in a similar manner.

Further features and advantages of the invention as well as the structure and operation of various embodiments of the invention are described in detail below with reference to the accompanying drawings.

### BRIEF DESCRIPTION OF THE FIGURES

The accompanying drawings, which are incorporated herein and form a part of the specification, illustrate the invention and, together with the description, further serve to explain the principles of the invention and to enable a person skilled in the pertinent art to make and use the invention.

In the drawings:

FIG. 1 is a block diagram illustrating the system architecture of an embodiment of the invention, showing network connectivity among the various components;

FIG. 2 is a block diagram illustrating an alternative embodiment of the system architecture of the invention, showing connectivity among the various components;

FIG. 3 is a block diagram illustrating the location code according to an embodiment of the invention;

FIG. 4A is a flowchart showing a routine for locator server according to an embodiment of the invention;

FIG. 4B is a flowchart showing a routine for locator client according to an embodiment of the invention;

FIG. 4C is a flowchart showing a routine for locator client according to another embodiment of the invention;

FIG. 5 is a diagram of an example internetwork environment according to the present invention;

FIG. 6 shows a simplified four-layered communication model supporting Web commerce; and

FIG. 7 is a block diagram of a computer system according to an example implementation of the present invention.

The invention will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION OF THE PREFERRED EMBODIMENTS

The invention is directed to a system, method, and computer program product for locator services. In one embodiment, a user of the present invention enters a location code and is presented with location information about the entity linked to the entered location code.

In one embodiment of the invention, the location code is designed for identifying and categorizing “points of interest” (POI) on online and offline maps. The location code contains locational and categorical information on every point of interest that is selected. Using the location code, a user can search or rapidly retrieve information from a location-related database.

In an embodiment, a POI is any physical location that would be of interest to a user. This would include but is not limited to restaurants, hotels, museums, theaters, retail stores, businesses, parks, Automatic Teller Machines (ATMs), public telephones, bus stops and monuments. However, a POI could also include any place that would like to be identified to search engines on the Internet, including even private residences or virtual businesses.

While the invention is described in terms of the above example, this is for convenience only and is not intended to limit its application. In fact, after reading the following description, it will be apparent to one skilled in the relevant art(s) based on the teachings herein how to implement the following invention in alternative embodiments (e.g., providing voice communication initiation systems for a corporate intranet or extranet).

Furthermore, while the following description refers to the global Internet which includes Web sites and fie transfer protocol (FTP) sites, and thus employs such terms as URL's (addresses) and Web pages (contents), it is not intended to limit the application of the invention. It will be apparent to one skilled in the relevant art how to implement the following invention, where appropriate, in alternative embodiments.

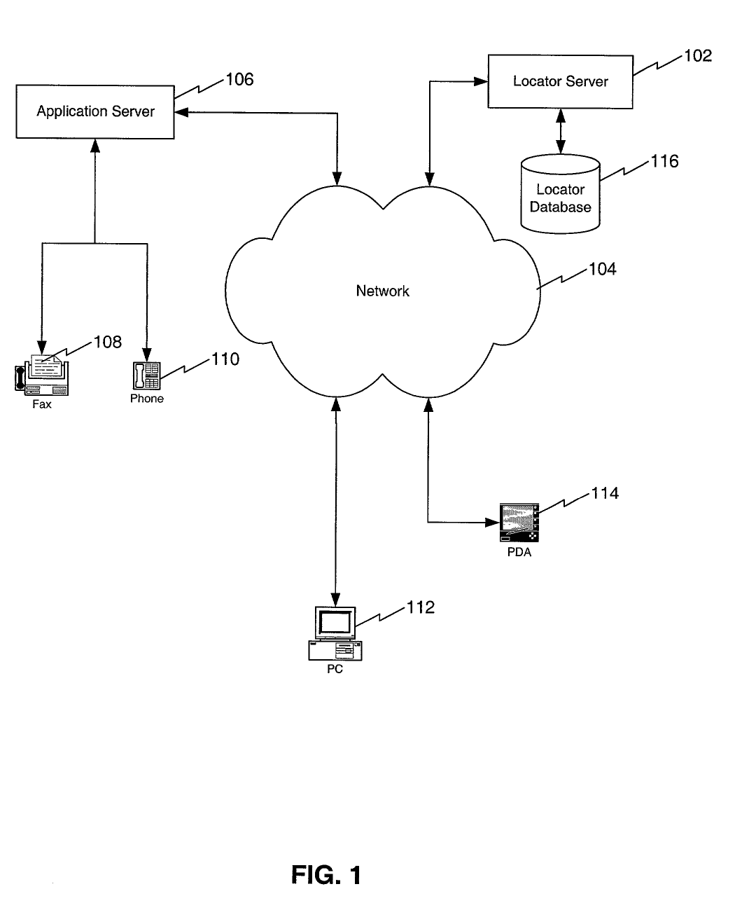

FIG. 1 is a block diagram illustrating the physical architecture of an locator system 100, according to an embodiment of the invention, showing the network connectivity among the various components. It should be understood that the particular locator system 100 in FIG. 1 is shown for illustrative purposes only and does not limit the invention. As will be apparent to one skilled in the relevant art(s), based on teachings herein that all of components “inside” of the locator system 100 are connected directly or via network 104.

The locator system 100 includes a locator server 102 connected to network 104, where network 104 can be the Internet. Personal computer (PC) 112, also connected to network 104, can make location queries to locator server 102.

In one embodiment, personal digital assistant (PDA) 114 can similarly request information of locator server 102.

Additionally, locator server 102 is coupled to locator database 116. Locator database 116 stored location codes and corresponding location information.

Furthermore, facsimile (fax) 108 and phone 110 can access locator server 102 via application server 106, which communicates with locator server 102 via network 104.

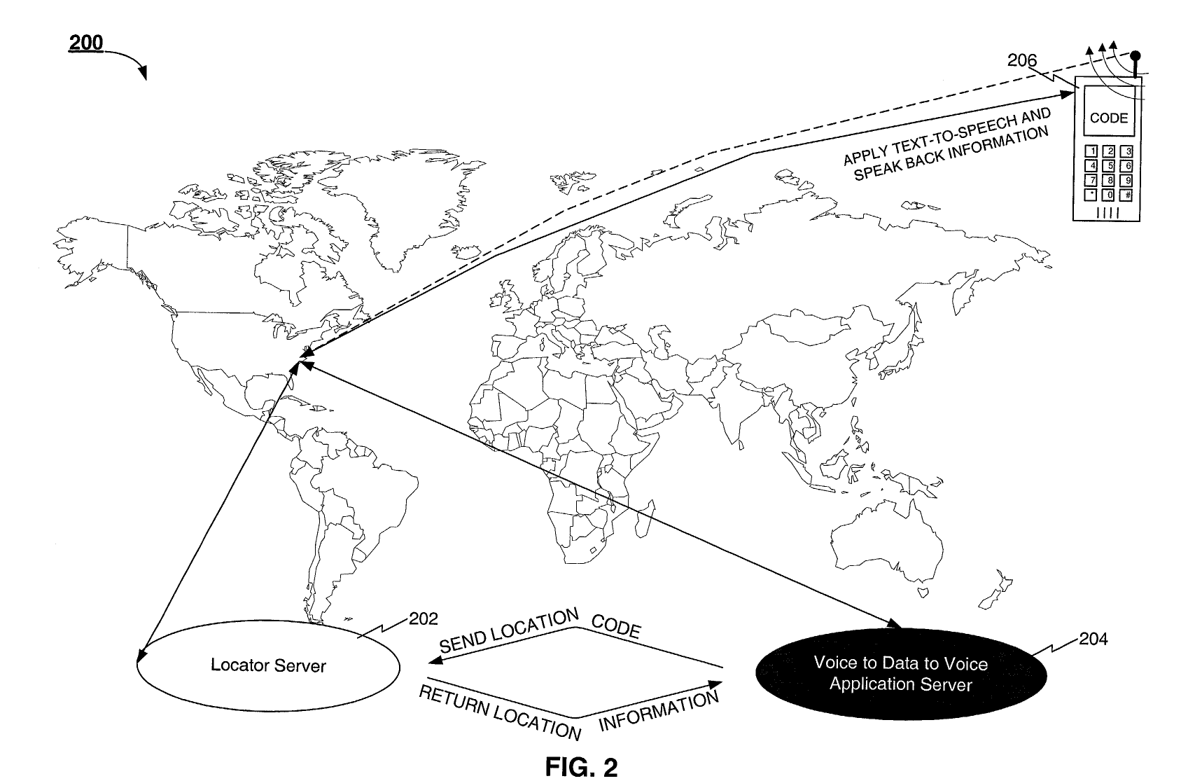

In another embodiment of the invention, as shown in FIG. 2, the components include a locator server 202, a voice application server 204, and phone 206. The locator server 202 includes various functional components. These components can be implemented in hardware or software or some combination of hardware and software. Locator server 202 processes location requests received from voice application server 204. Voice application server 204 processes voice data from phone 206 and converts any included location requests into a format readable by locator server 202.

While only one each of locator server 202, voice application server 204, phone 206 is shown in FIG. 2, it will be apparent to one skilled in the relevant art(s) based on the teaching herein that locator system 100 may be run in a distributed fashion over a plurality of the above-mentioned network elements connected via network 104, as shown in FIG. 1.

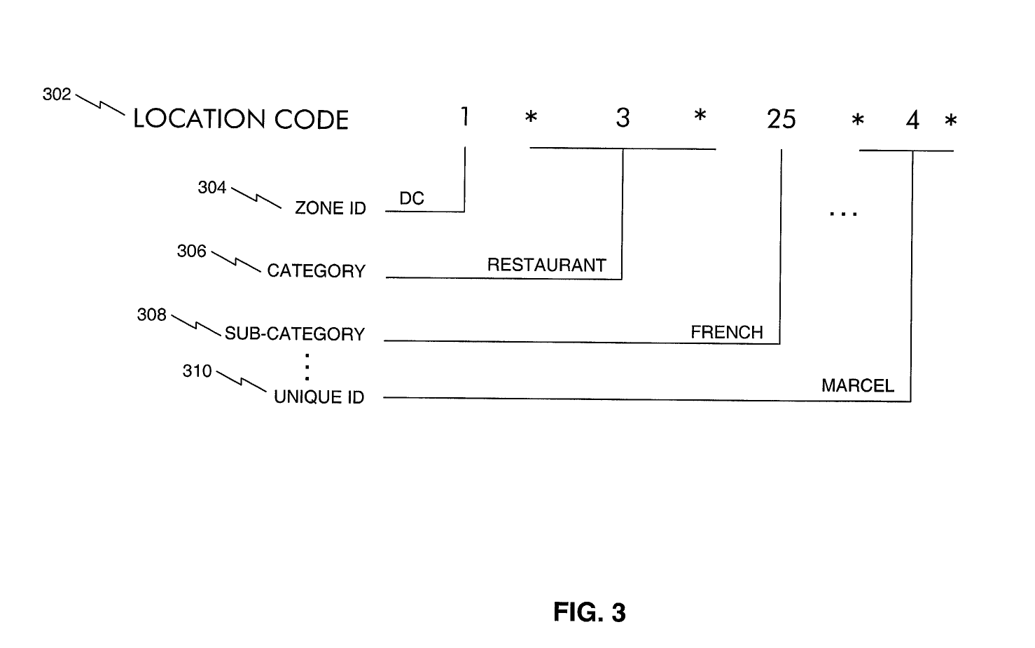

Referring to FIG. 3, a block diagram of the location code, according to an embodiment of the invention, is shown. In this embodiment, the location code is based on four attributes, each represented numerically and delineated by an * or other accessible character as a delineating character in the following order—Zone ID 304*Category 306*Sub-Category 308*Unique Identifier 310*.

These are possible embodiments. Other implementations are possible based on the teachings described herein. In another embodiment, a fifth attribute is included and further delineated by an *. For instance, an attribute for specific travel club approval, or an attribute that signal acceptance by the locale of a particular form of payment (cash, check, credit card).

In another embodiment, additional attributes can be added, either nested or not, such that the location code provides the ability to trigger specific location information, such as returning only facsimile numbers, or forms of payment. Additionally, certain attributes can be linked to specific functions, such as paging a locale or entity, or sending an email. The present invention is not limited to the examples provided here, and as one skilled in the relevant art(s) would recognize based on the teachings described herein other functions may be implemented.

According to an embodiment, 1*3*24*5* is the location code for Marcel Restaurant in Washington, D.C.—1*: Washington; 3*: Restaurant Category; 24*: French Restaurant Sub Category; and 5*: Marcel's Unique Identifier among all French Restaurants in Washington.

By entering this number into a locator client (such as a wireless device connected to network 104) connected to locator server and locator database, a user can immediately retrieve location information on Marcel Restaurant, including address, telephone, fax, email, web site address, reviews, menus, photographs, video recordings, live video feeds, sound recordings, etc.

The delineating character allows for infinite scalability as there is no limit to the number of digits for each attribute. It also allows for groups of locations with a common attribute to be searched. For example: 1*3*25** would retrieve a listing of all French restaurants in Washington, D.C. This is just one embodiment including automatic wildcarding. Other embodiments are possible given the descriptions given herein.

In one implementation, location codes will be assigned to relevant points of interest on offline and online maps of major urban centers and travel destinations worldwide. The location codes will be featured on these distributed maps as a direct way to get online information about the POI, for example, via cellular phones.

By using a location code or sub-string of a location code, a user can be certain that the query is retrieving information on the exact POI for which location information is requested. This allows a user with a paper map to read the location code from the map and easily enter it at the locator server by using any device that can access the site. This retrieves information about any POI that locator database covers, in one step, without the need for browsing through layers of categories to get at the information on a particular POI.

As described herein, a delineating character can be inserted into any one of the four attribute segments as a place-holder during a search. This allows data retrieval for all attributes with the other three (or two or one) numeric segments.

In one embodiment, the location code as a “universal communication” number for every locale, entity, and/or individual. The location code references a locator database with information on all of the methods for communicating with the locale: telephone number, fax number, cellular number, street address, post office box, email address, web page address, Internet protocol (IP) address, and/or GPS coordinates, however, is not intended to be limited to any of these location identifiers, and can be implemented in any location identifier, developed now or in the future, as would be apparent to a person skilled in the art given this description.

Depending on the type of device being used by the user, or by choosing which form of communication desired, the system uses the location code to route the communication through that channel. For example, by dialing a location code into a fax machine, the fax number for the locale is retrieved and the fax call connected. Likewise, a location code can be used as an email address, and the email message would be routed to the email address on file on the locator database. And a location code used as a web address on an Internet navigation browser would go to the URL designated in the locator database.

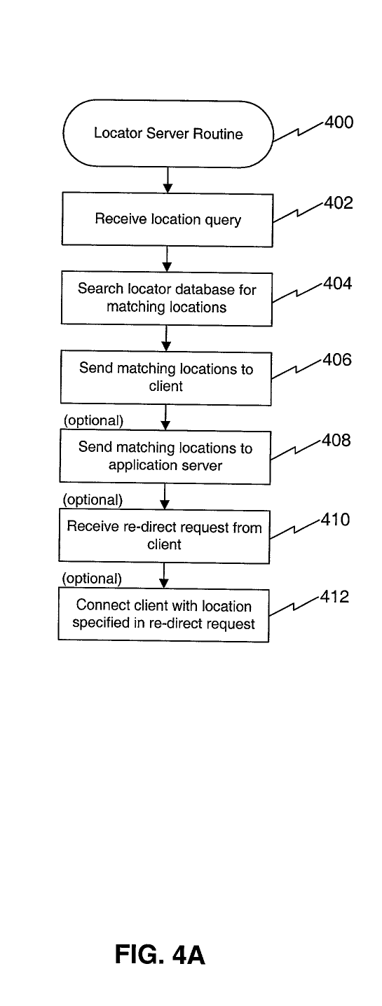

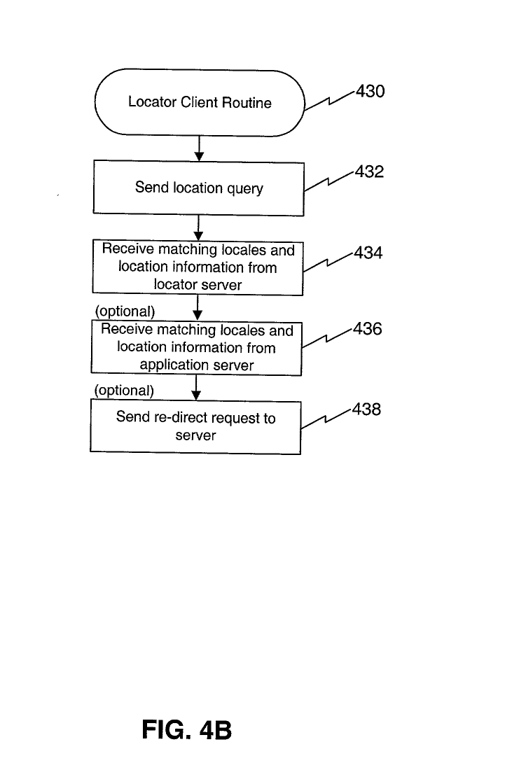

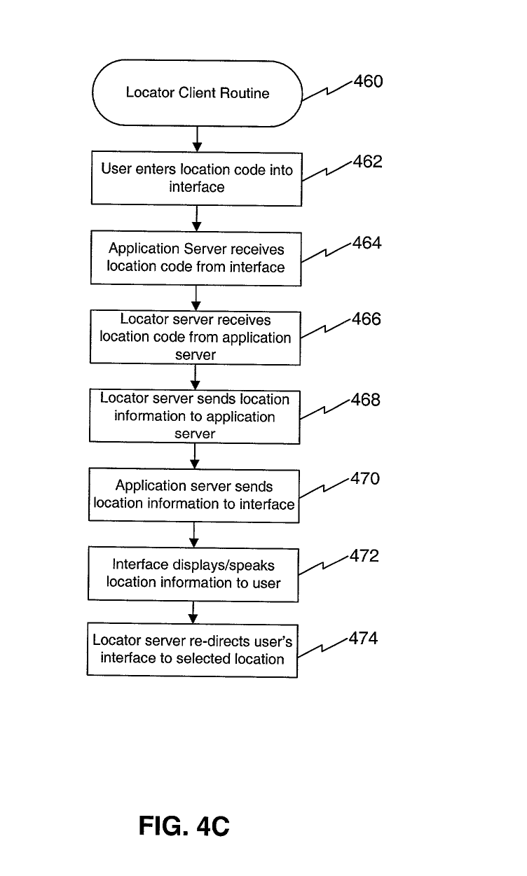

FIG. 4A shows a flowchart 400 of a routine for a locator server of the locator system 100, according to an embodiment of the invention.

In step 402, locator server 102 receives a location query. In one embodiment, the location query comprises a location code.

In step 404, locator server 102 searches locator database 116 for matching records containing location information.

In step 406, locator server 102 sends the location information for matching records to the client.

In optional step 408, locator server 102 sends the location information to application server 106. In one embodiment, the locator server 102 sends the location information to the application server 106 in the event that the client is not using a device connected to the network 104. In another embodiment, the locator server 102 sends the location information to the application server 106 in the event that the application server 106 is operated by a service provider or a merchant, described in greater detail below.

In optional step 410, locator server 102 receives a re-direct request from the client. In one embodiment, a re-direct request comprises a connecting telephone call between the client and the locale provided in the location information for a matching record.

FIG. 4B shows a flowchart 430 of a routine for a locator client of the locator system 100, according to an embodiment of the invention.

In step 432, locator client (such as one implemented on PC 112) sends a location query to the locator server 102.

In step 434, locator client receives matching locations and location information from locator server 102.

In optional step 436, locator client (such as one implemented on phone 110) receives matching locations and location information from application server 106.

In optional step 438, locator client sends a re-direct request to locator server 102.

FIG. 4C shows a flowchart 460 of a routine for a locator client of the locator system 200, according to another embodiment of the invention.

In step 462, a user enters location code(s) into an interface.

In step 464, application server receives location code(s) from an interface.

In step 466, a locator server receives location code(s) from an application server.

In step 468, locator server sends location information to application server.

In optional step 470, an application server sends location information to an interface, e.g., to make restaurant reservations.

In step 474, locator server re-directs a user's device to a selected location.

The above-mentioned figures are exemplary illustrations of features of the present invention and are not intended to limit the present invention in any way.

Additional Embodiments

In one embodiment of the present invention, the system 100 provides services to one or more users. The one or more users access the system 100 from fax 108, phone 110, PC 112, and/or PDA 114 (or equivalent devices). The one or more users can use the POI codes 300 to search for information related to a specific business. The POI code 300 is entered via the fax 108, phone 110, PC 112, and/or PDA 114, or the like, in order to access the information associated with that specific business. For example, the POI code 300 can be printed on a travel map near a sign or icon representing the location of the business. The POI code 300 may also be located in the yellow pages or similar directory.

In one embodiment, the user enters the POI code 300 into a user interface on one of the devices 108-114. The device transmits a query to a remote application server 106 (or locator server 102) that searches a POI database 116 via the network 104 and retrieves the record associated with the POI code 300. The server 106 then sends to the device a summary of fields within the POI record. The user can then browse the contents of each field.

In greater detail, the user is in possession of the POI code 300 for an Italian restaurant in London. The user enters the POI code 300 into a user interface by whatever means the operating system supports (e.g. voice or keyboard input). The query results then show a range of information related to the restaurant such as address, photographs and which credit cards accepted. The user can then execute commands related to the contents of each field within the record. For example the user can forward the photograph to a colleague via email. The user can also seek directions to the restaurants address given that one of the fields within the POI record contains latitude and longitude information that can be resolved with the users location as identified by, for example, a GPS device to create navigation directions. In one embodiment, the user enters his location via the devices 108-114. This location may be identified with a POI code 300. The user can also provide the POI record information to additional and varying services both connected to or external from the network 104.

In another embodiment of the present invention, the system 100 provides services to one or more users. The user is searching for a set of POIs that share a common attribute. For example the user with a hand-held device wishes to know which Italian restaurants are nearby.

The user constructs a query by using a user interface such as pop up menus to define the characteristics of the POI record information being sought. For example, the user uses a menu system to select ‘restaurants’ and then to select a subset ‘Italian’. The interface then matches these selections to corresponding POI code 300 attribute segments and transmits a query to the POI server 102 which then responds with the results of the search of locator database 116. The user can then sort the results according to attributes defined within the fields in the POI record. For example the user can refine the search for Italian restaurants to those within a specific price range.

The user can select a specific POI code 300 from the subset of retrieved POI codes 300, the POI code 300 associated with that POI can be used to facilitate communications with the location in question. In this example, the user has selected a specific Italian restaurant. The POI record for the Italian restaurant includes several fields for communications identifiers such as telephone and fax numbers or email addresses. The user can then choose to execute a communications session with the business by selecting the preferred mode of communication and using the identifier to trigger a communications session. For example by selecting the email address in conjunction with a specific function, the user would commence an email communication session with the Italian restaurant.

In an alternative embodiment of the present invention, the system 100 provides services to one or more service providers. An information service provider can be a licensee, subscriber or user of the system 100. The service provider can respond to user queries for information related to a POI by providing a combination of public domain and proprietary information in any media format. The unique POI code 300 associated with each POI is used as unifying reference for the aggregation of information related to that POI.

In an alternative embodiment of the present invention, the system 100 provides services to one or more merchants. A merchant can operate a retail store, registers the merchant's operations by providing information for specific POI attribute fields including location and characteristics of business. The merchant is provided with a unique POI code 300 that in itself captures some attributes of his business, as well as pointing to the POI record that contains further information related to the business. The POI code 300 is then utilized by a wide range of subscribers, licensees and other users of the system and service to identify the business and retrieve information related to the business. The merchant can update the POI attributes of his business at any time through accessing the system 100 through devices 108-114. These changes are propagated to subscribers, licensees and other users of the system 100.

In an alternative embodiment of the present invention, the system 100, which provides services to one or more users, providers, and/or merchants, can be configured to verify identity, or the like prior to providing access to the system 100. The system 100 can also maintain an account for each user, provider, and/or merchant.

Example Network Environment

The present invention can be implemented in any communication network, such as, the Internet, which supports interactive services and applications. In particular, the present invention can be implemented in any Web service, preferably a Web service supporting secure transactions, such as, the Secure Socket Layer (SSL) protocol and/or using a Secure HyperText Transport Protocol (S-HTTP). In one example, the present invention is implemented in a multi-platform (platform independent) programming language such as Java™ 1.1. Java™-enabled and JavaScript™-enabled browsers are used, such as, Netscape™, HotJava™, and Microsoft™ Explorer™ browsers. Active content Web pages can be used. Such active content Web pages can include Java™ applets or ActiveX™ controls, or any other active content technology developed now or in the future. The present invention, however, is not intended to be limited to Java™, JavaScript™, or their enabled browsers, and can be implemented in any programming language and browser, developed now or in the future, as would be apparent to a person skilled in the art given this description.

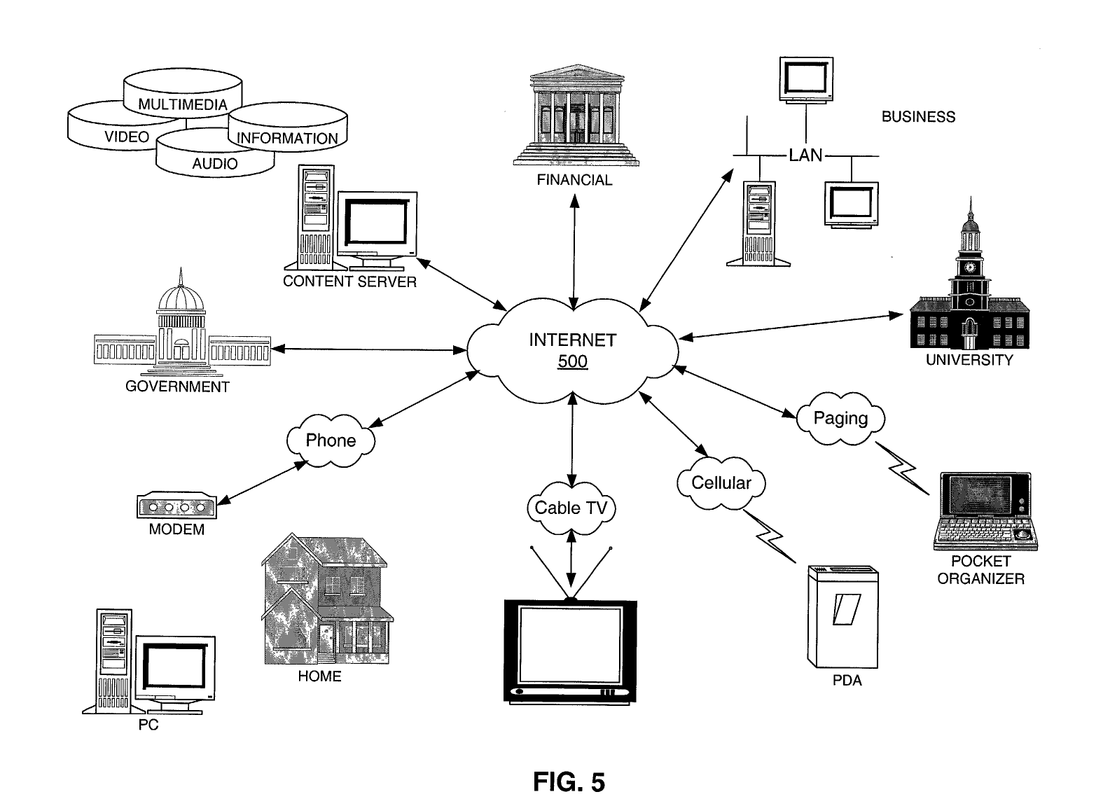

FIG. 5 is a diagram of an example internetwork environment according to the present invention. FIG. 5 shows a communication network or combination of networks (Internet) 500 which can support the invention. Internet 500 consists of interconnected computers which supports communication between many different types of users including businesses, universities, individuals, government, and financial institutions. Internet 500 supports many different types of communication links implemented in a variety of architectures. For example, voice and data links can be used including phone, paging, cellular, satellite and cable TV (CATV) links. Terminal equipment can include local area networks, personal computers with modems, content servers of multi-media, audio, video, and other information, pocket organizers, Personal Data Assistants (PDAs), and set-top boxes.

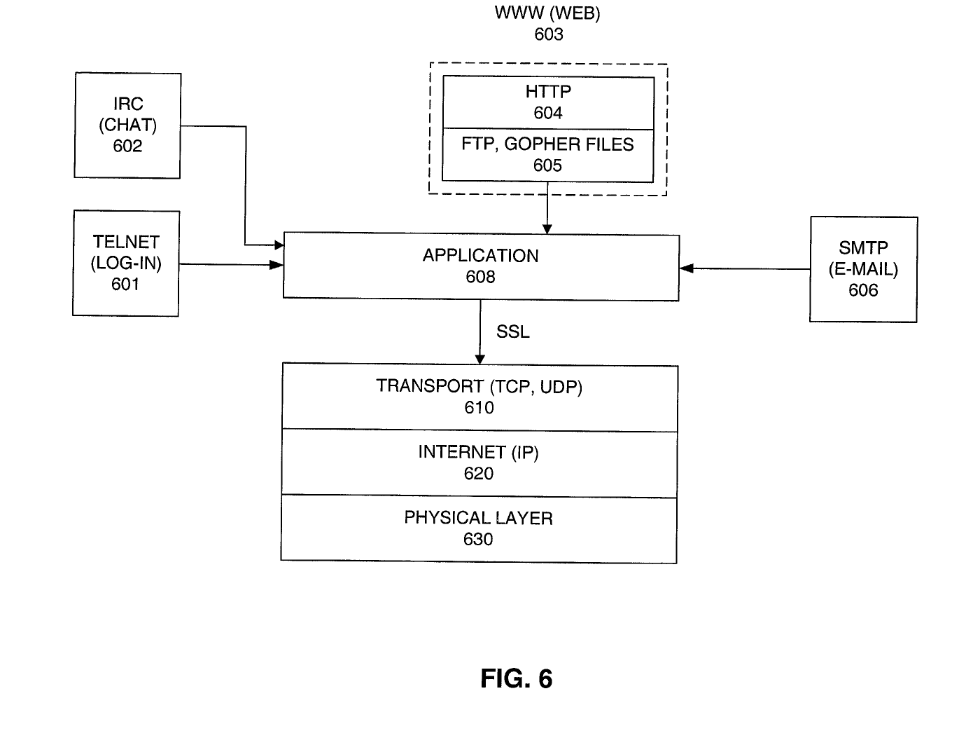

Communication over a communication network such as, Internet 500, is carried out through different layers of communication. FIG. 6 shows a simplified four-layered communication model supporting Web commerce including an application layer 608, transport layer 610, Internet layer 620, physical layer 630. As would be apparent to a person skilled in the art, in practice, a number of different layers can be used depending upon a particular network design and communication application. Application layer 608 represents the different tools and information services which are used to access the information over the Internet. Such tools include, but are not limited to, Telnet log-in service 601, IRC chat 602, Web service 603, and SMTP (Simple Mail Transfer Protocol) electronic mail service 606. Web service 603 allows access to HTTP documents 604, and FTP and Gopher files 605. A Secure Socket Layer (SSL) is an optional protocol used to encrypt communications between a Web browser and Web server.

Description of the example environment in these terms is provided for convenience only. It is not intended that the invention be limited to application in this example environment. In fact, after reading the following description, it will become apparent to a person skilled in the relevant art how to implement the invention in alternative environments.

Example Computer System

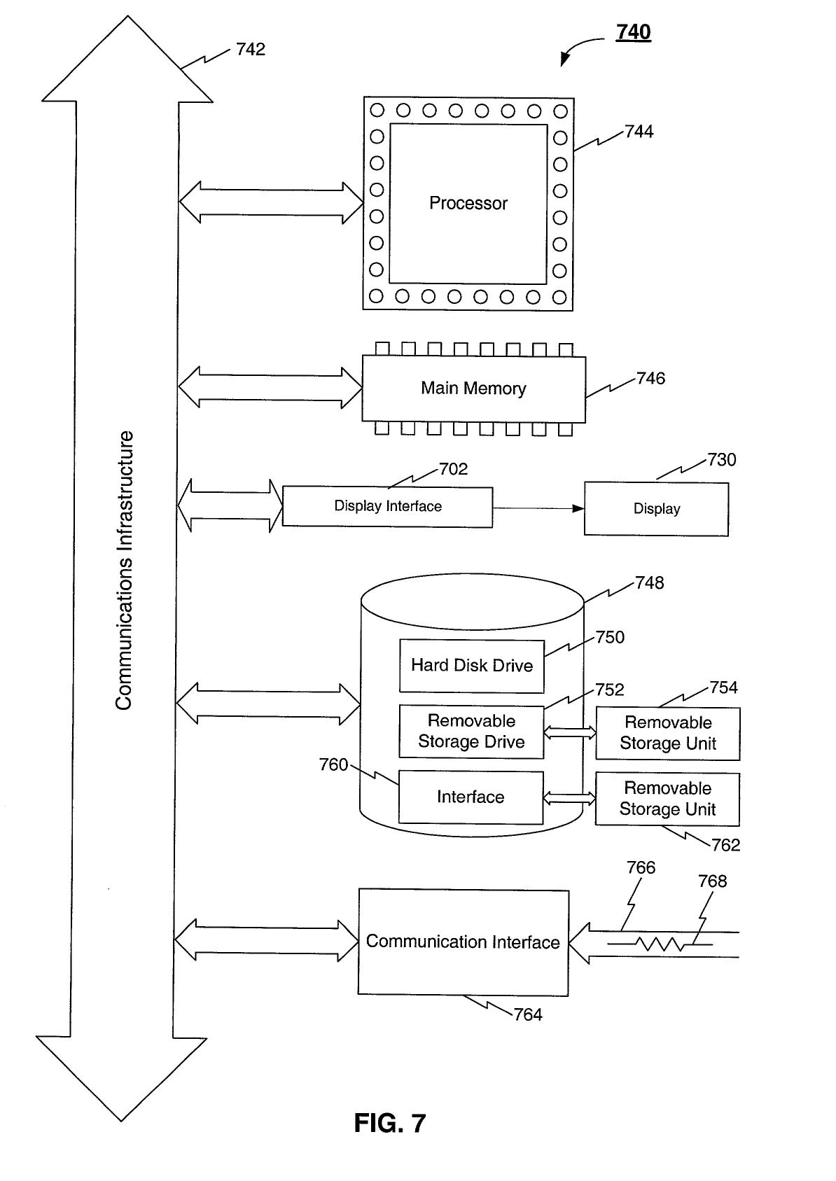

An example of a computer system 740 is shown in FIG. 7. The computer system 740 represents any single or multi-processor computer. In conjunction, single-threaded and multi-threaded applications can be used. Unified or distributed memory systems can be used.

Computer system 740 includes one or more processors, such as processor 744. One or more processors 744 can execute software implementing routine 300 and 400 as described above. Each processor 744 is connected to a communication infrastructure 742 (e.g., a communications bus, cross-bar, or network). Various software embodiments are described in terms of this exemplary computer system. After reading this description, it will become apparent to a person skilled in the relevant art how to implement the invention using other computer systems and/or computer architectures.

Computer system 1100 can include a display interface 702 that forwards graphics, text, and other data from the communication infrastructure 742 (or from a frame buffer not shown) for display on the display unit 730.

Computer system 740 also includes a main memory 746, preferably random access memory (RAM), and can also include a secondary memory 748. The secondary memory 748 can include, for example, a hard disk drive 750 and/or a removable storage drive 752, representing a floppy disk drive, a magnetic tape drive, an optical disk drive, etc. The removable storage drive 752 reads from and/or writes to a removable storage unit 754 in a well known manner. Removable storage unit 754 represents a floppy disk, magnetic tape, optical disk, etc., which is read by and written to by removable storage drive 752. As will be appreciated, the removable storage unit 754 includes a computer usable storage medium having stored therein computer software and/or data.

In alternative embodiments, secondary memory 748 may include other similar means for allowing computer programs or other instructions to be loaded into computer system 740. Such means can include, for example, a removable storage unit 762 and an interface 760. Examples can include a program cartridge and cartridge interface (such as that found in video game devices), a removable memory chip (such as an EPROM, or PROM) and associated socket, and other removable storage units 762 and interfaces 760 which allow software and data to be transferred from the removable storage unit 762 to computer system 740.

Computer system 740 can also include a communications interface 764. Communications interface 764 allows software and data to be transferred between computer system 740 and external devices via communications path 766. Examples of communications interface 964 can include a modem, a network interface (such as Ethernet card), a communications port, etc. Software and data transferred via communications interface 764 are in the form of signals which can be electronic, electromagnetic, optical or other signals capable of being received by communications interface 764, via communications path 766. Note that communications interface 764 provides a means by which computer system 740 can interface to a network such as the Internet.

The present invention can be implemented using software running (that is, executing) in an environment similar to that described above with respect to FIG. 5. In this document, the term “computer program product” is used to generally refer to removable storage unit 754, a hard disk installed in hard disk drive 750, or a carrier wave carrying software over a communication path 766 (wireless link or cable) to communication interface 764. A computer useable medium can include magnetic media, optical media, or other recordable media, or media that transmits a carrier wave or other signal. These computer program products are means for providing software to computer system 740.

Computer programs (also called computer control logic) are stored in main memory 746 and/or secondary memory 748. Computer programs can also be received via communications interface 754. Such computer programs, when executed, enable the computer system 740 to perform the features of the present invention as discussed herein. In particular, the computer programs, when executed, enable the processor 744 to perform the features of the present invention. Accordingly, such computer programs represent controllers of the computer system 740.

The present invention can be implemented as control logic in software, firmware, hardware or any combination thereof. In an embodiment where the invention is implemented using software, the software may be stored in a computer program product and loaded into computer system 1240 using removable storage drive 752, hard drive 750, or interface 760. Alternatively, the computer program product may be downloaded to computer system 740 over communications path 766. The control logic (software), when executed by the one or more processors 744, causes the processor(s) 744 to perform the functions of the invention as described herein.

In another embodiment, the invention is implemented primarily in firmware and/or hardware using, for example, hardware components such as application specific integrated circuits (ASICs). Implementation of a hardware state machine so as to perform the functions described herein will be apparent to persons skilled in the relevant art(s).

Conclusion

While various embodiments of the invention have been described above, it should be understood that they have been presented by way of example, and not limitation. It will be apparent to persons skilled in the relevant art that various changes in form and detail may be made therein without departing from the spirit and scope of the invention. This is especially true in light of technology and terms within the relevant art(s) that may be later developed. Thus the invention should not be limited by any of the above-described exemplary embodiments, but should be defined only in accordance with the following claims and their equivalents.

What is claimed is:

1. A method for providing location information, comprising:
(a) receiving a query containing at least one location code;
(b) searching a database for location information using said at least one location code; and
(c) returning matching location information to a client.

2. The method of claim 1, further comprising:
(d) sending said matching location information to an application server;
(e) receiving a re-direct request from said client; and
(f) connecting said client with a location specified in said re-direct request.

3. The method of claim 1, wherein said location information includes one or more street addresses, phone numbers, e-mail address, and universal resource locators.

4. The method of claim 1, wherein a location server, coupled to said database, receives said query.

5. The method of claim 1, wherein said database includes said location information and said at least one location code.
